(19) United States
(12) Patent Application Publication
(10) Pub. No.: US 2007/0209891 A1
(43) Pub. Date: Sep. 13, 2007

(54) Disk Brake

(76) Inventors: Goran Stensson, Brosarp (SE); Stefan Sandberg, Lomma (SE)

Correspondence Address: ST. ONGE STEWARD JOHNSTON & REENS LLC, 986 Bedford Street, Stamford, CT, 06905-5619, US

(21) Appl. No.: 11/682,979

(22) Filed: Mar. 7, 2007

(30) Foreign Application Priority Data
Mar. 8, 2006 (DE) 10 2006 010 754.3

(51) Int. Cl. F16D 65/04

(52) U.S. Cl. 188/247

(57) ABSTRACT

The present invention relates to a disk brake in which a connection is configured between a brake lining retainer and a pressure plate of a push rod in order to move the push rod by means of the brake lining retainer so that it slides axially in a brake caliper

### CROSS-REFERENCE TO RELATED APPLICATIONS

The present application claims priority of German patent application No. 10 2006 010 754.3 filed on Mar. 8, 2006, the content of which is incorporated herein by reference.

### FIELD OF THE INVENTION

The present invention relates to a disk brake, in particular for motor vehicles, as well as a brake lining retainer for use in such a disk brake.

### BACKGROUND OF THE INVENTION

Disk brake systems of the most varied construction types share a common aim, which is, on the one hand, to keep the structural mass and the weight as low as possible and, on the other hand, to configure the assembly and construction in a motor vehicle as simply as possible, without having to accept reductions in the mode of functioning and the life expectancy of the disk brake.

Among disk brakes known in the prior art, a brake actuation mechanism is usually provided inside a brake caliper housing and this mechanism includes a reinforcing mechanism, for instance an eccentrically mounted lever, and a push rod connected with the reinforcing mechanism that may be for instance a traverse, where the lever, which is actuated by a pressure cylinder, reinforces the braking force arising from the cylinder through the eccentric installation and transmits these forces to the traverse, which is then slid forward in the direction toward the brake disk that is overlapped by the brake caliper.

The push rod or the traverse is provided with a push plate on the brake disk end, and this push plate comes into contact with a brake lining retainer, presses it against the brake disk, until the brake lining touches the brake disk and thus injects the braking force into the brake disk.

For this purpose the push rod must be conducted to slide axially in the housing of the brake caliper. While the push rod in the area of the reinforcement mechanism is conducted in the brake caliper housing, the pressure plate, on the one hand, can be conducted on the interior on the arms or blades of the brake caliper that overlap the brake disk or, in the case of a sliding caliper brake, on a carrier of the brake caliper. On the other hand, the push rod can also be conducted in the brake caliper housing in the area of the opening, which is opposite the brake disk.

In all cases the respective conductor gliding surfaces in the housing of the brake caliper must, as far as is possible within the limits of their construction, be separate in order to allow perfect axial conduct of the push rod, which essentially is intended to prevent a tipping of the push rod when the braking force is actuated. This requires corresponding glide surfaces that are to be processed to ensure the quality of the surface, on the outer surface of the push rod, on the one hand, and on the inner surface of the brake caliper housing on the other hand. In particular, inside the brake caliper housing such a reprocessing of the brake caliper body, which as a rule consists of cast iron, is expensive.

In addition, many slide surfaces, despite appropriate surface qualities, lead to increased frictional forces, thereby increasing the demands on the precision of the pressingly necessary adjustment spindles in such disk brakes, which are conducted so that they can rotate, for instance, in the traverse. Both the reprocessing of slide surfaces and the corresponding design and construction of the adjustment mechanisms for producing a perfect adjustment function under all conditions lead to increased production costs.

The pressure plate on the brake disk end of the push rod transmits the pressure by means of braking force onto the brake lining retainer and must distribute this pressure correspondingly over the surface of the brake lining. The brake lining retainer with the brake lining is conducted radially and tangentially on the housing of the brake caliper for a fixed caliper brake or on a brake caliper bearer for a sliding caliper brake.

To distribute the braking force, the pressure plate includes regularly large dimensions and is heavy and thus costly to produce. In addition the dimensions of the pressure plate cause the variability and freedom of the design of the brake caliper to be restricted precisely to such areas on which increased mechanical tensions occur in the caliper body, in particular in the transition area between the brake caliper housing, in which the actuation mechanism is mounted, and the arms and blades of the brake caliper extending out of the housing, which overlap the brake disk.

Consequently it is an object of the present invention to produce a new type of disk brake, which avoids the aforementioned problems and disadvantages.

### SUMMARY OF THE INVENTION

This object is fulfilled with a disk brake having the characteristics of claim 1 and with a brake lining retainer for such a disk brake having the characteristics of claim 13.

The invention is based on the fact that the pressure plate, which is provided on the brake disk end of the push rod, is connected with the brake lining retainer so that it transmits force in such a way that both during brake actuation, when the brake lining is applied against the brake disks, and also during braking force release, when the brake lining for lack of further pressure force, for instance a rebound spring, is moved back, the push rod is moved so that it slides axially in the brake caliper by means of the brake lining retainer.

This axial motion, in turn, is caused by the fact that the brake lining retainer is moved radially and tangentially and therefore also axially with the brake lining either in a brake caliper housing or in a brake caliper carrier.

Because of the inventive design, there is no longer any necessity of providing slide surfaces for the push rod that are correspondingly processed, on the brake disk end of the housing of the brake caliper, on the inner surfaces of the arms of the brake caliper, or on the inner surfaces of the carrier in the case of a sliding caliper brake, and thus costs are minimized.

Because of the force-transmitting and guiding connection between the brake lining retainer and the pressure plate, the plate can be configured much smaller. The plate must merely be of sufficient size to ensure an adequate distribution of the tensing force over the brake lining.

Because the guide surfaces of the brake lining retainer, according to the invention, also serve as slide surfaces for the axial motion of the push rod in the brake caliper housing, the avoidance of the axial slide surfaces in the area of the opening on the brake disk side in the housing causes a reduction of the friction resistance overall by about one-third. This in turn ensures a perfect functioning of the replacement mechanism, even in a simpler, lower-tolerance construction.

The substantially smaller configuration of the pressure plate, in addition, makes possible an overall more compact structure of the brake caliper along with a reduction in weight. Critical areas in the brake caliper itself, areas in which considerable mechanical impacts occur during the braking process, for instance on the transition areas between the brake caliper housing and the arms surrounding the brake disk, can be configured for greater stability because, owing to the smaller pressure plate, more construction room and thus freedom of configuration become available.

The surface treatment for the second axial slide surfaces in the brake caliper housing is dispensed with, for a reduction in production costs.

The inventive configuration of the connection between the pressure plate and the brake lining retainer can be used both with fixed and with sliding caliper brakes. Nor is the invention restricted to certain types of push rods, but rather the pressure plates can work in traverses with two parallel adjustment spindles and also in cylindrical pressure cams.

According to the invention, the connection between the pressure plate and the brake lining retainer, a connection which allows an axial motion of the push rod, relies on the fact that the pressure plate, facing the brake disk, has at least one connecting element that interacts with a form-complementing connecting element, which is positioned on the brake lining retainer on its side facing away from the brake disk.

In one embodiment the pressure plate can take the form of a preferably cylindrical projection or stud, which points toward the brake disk and engages in a corresponding form-complementing recess in the brake lining retainer.

In another embodiment, such a stud or projection is provided on the brake lining retainer, pointing toward the brake caliper housing, and engages in a corresponding recess in the pressure plate.

In both cases it is advantageous if at least two projections and recesses, at a distance from one another, are provided at the same time in order to produce radial and tangential stability.

In a preferred embodiment the brake lining retainer includes a recess, whose dimensions correspond to the peripheral shape of the pressure plate in form-complementing manner, so that the pressure plate is enclosed completely in this recess.

In another preferred embodiment the surface of the brake lining retainer turned toward the pressure plate has two projections facing one another, which hold the pressure plate, enclosing its sides. The configuration of the projections is adapted to the shape and the side surfaces of the pressure plate; they are preferably configured as essentially U-shaped edges, so that a radial and tangential fixing of the pressure plate is ensured.

It is common to all embodiments that the connection between the pressure plate and the brake lining retainer is mechanically configured in such a way that a radial and tangential relative motion between these elements is avoided. Nevertheless, according to the invention, the diverse connecting elements can be configured in such a way that between them at least sufficient clearance is provided to facilitate replacement of the brake linings or brake lining retainers.

It is precisely the inventive principle of connecting the pressure plate with the brake lining retainer that simplifies not just a replacement of the brake linings, but also allows a simpler installation of the actuation mechanism with the push rod in the brake caliper housing itself.

Because in the front opening area of the brake caliper housing no axial guide surfaces must be provided for the push rod, since this task is assumed by the guide and mounting surfaces of the brake lining retainer in the brake caliper or in the brake caliper carrier, the brake caliper housing and also the push rod can be considerably shorter, thus further reducing the outer dimensions of the disk brake and thus the necessary construction area. The resulting better accessibility also simplifies installation of such a disk brake in a vehicle.

In another preferred embodiment, in addition, a spring clamp is provided, which is installed to overlap the brake lining retainer and the pressure plate in order to keep them in a firm connection, in particular during brake force release and in the resting position. The push rod is moved back, usually by means of a pressure spring, which acts between the brake caliper housing and the push rod if no further braking force is applied by means of the reinforcing mechanism.

The spring clamp thus also draws the brake lining retainer and thus the brake lining back from the brake disk in an effective manner. This avoids the risk of a dragging the brake lining through the revolving brake disk during a braking force release. In addition the spring clamp avoids the formation of disturbing vibrating noises.

Whereas the push rod is mounted axially on the brake disk side by means of the guide surfaces of the brake lining retainer, axial guide surfaces for the end facing away from the brake disk of the push rod are provided for the configuration of the axial motion in the housing of the brake caliper in immediate vicinity of the reinforcing mechanism. Alternatively, the push rod here too can be directed by segments of the reinforcement mechanism mounted on these guide surfaces or of the replacement device, which are connected with the push rod. Preferably these correspondingly processed guide surfaces are configured as four slide surfaces diagonally opposite to one another.

The invention relates to a brake lining retainer as such, which has realized the aforementioned characteristics.

Further advantages and characteristics can be found in the following description of the embodiments, with reference to the appended illustrations.

### BRIEF DESCRIPTION OF THE DRAWINGS

FIG. 1a shows a perspective depiction of a push rod with a pressure plate and also of a brake lining retainer having a brake lining of the disk brake according to the invention in a first embodiment.

FIG. 1b shows these elements in another perspective view.

FIG. 2 shows a disk brake according to the invention in an aerial view of the first embodiment.

FIG. 3 shows a sectional view along the line B-B of FIG. 2.

FIG. 4 shows a sectional view along the line C-C of FIG. 2.

FIG. 5a shows a perspective view of a push rod with a pressure plate and also of a brake lining retainer having a brake lining of the disk brake according to the invention, in a second embodiment.

FIG. 5b shows these elements in another perspective view.

FIG. 6 shows a perspective depiction of a push rod having a pressure plate as well as of a brake lining retainer having a brake lining of the disk brake according to the invention, in a third embodiment.

FIG. 7a shows a perspective depiction of a push rod having a pressure plate as well as of a brake lining retainer having a brake lining of the disk brake according to the invention, held together with a spring clamp.

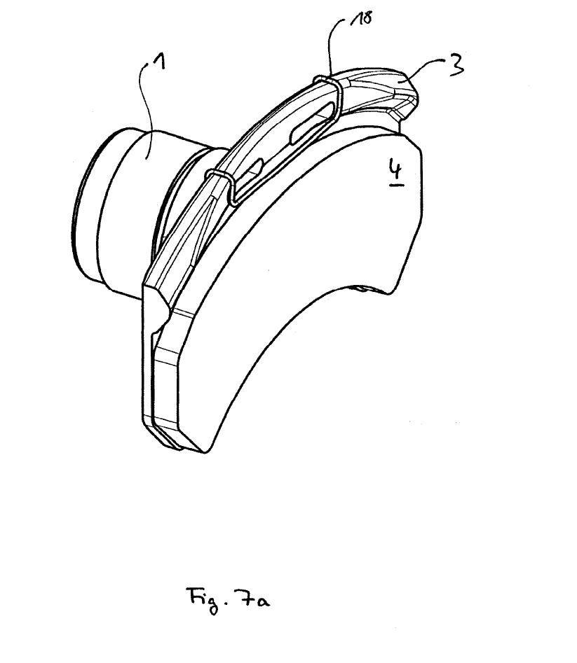

FIG. 7b shows these elements in another perspective view.

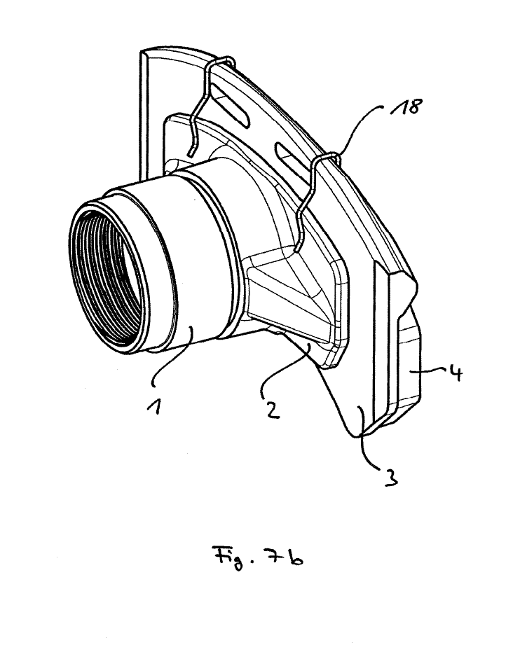

### DETAILED DESCRIPTION OF THE INVENTION

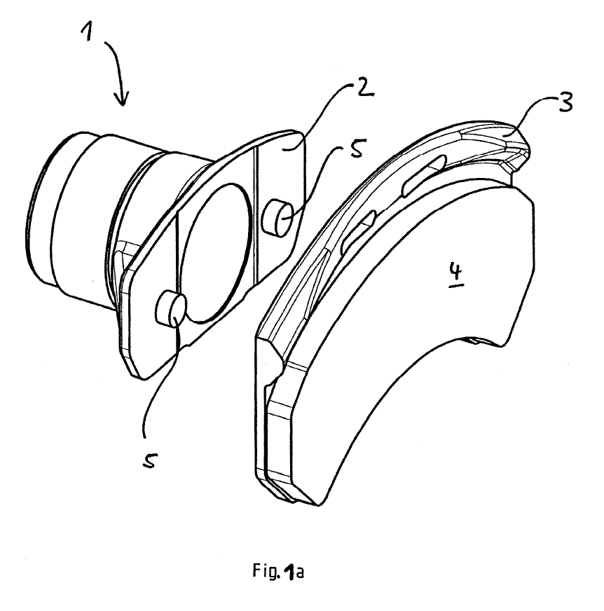

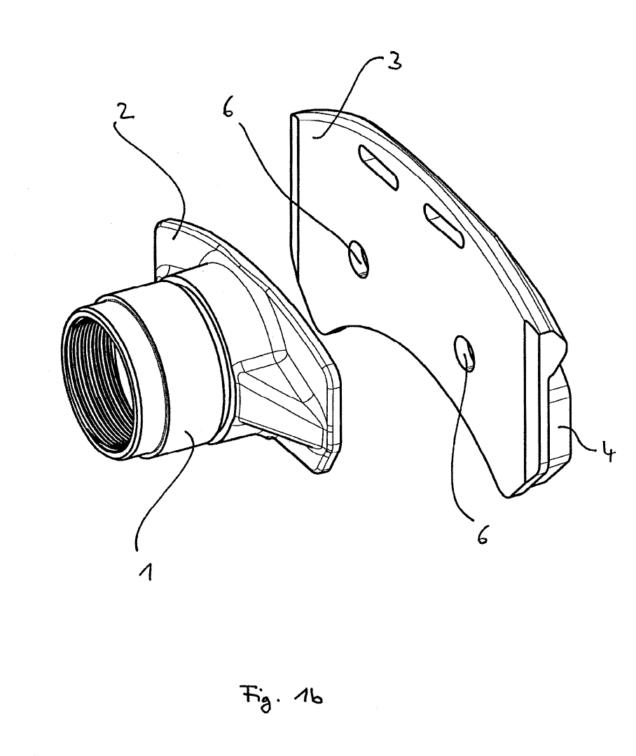

FIGS. 1a and 1b present examples of a few parts of the disk brake according to a first embodiment, including a cylindrical push rod 1 having a pressure plate positioned on it, and a brake lining retainer 3 having a brake lining 4 positioned on it. The push rod 1 is actuated by a reinforcing mechanism, not shown in further detail here, and is positioned in a brake caliper housing.

The pressure plate 2, on its surface facing the brake lining retainer 3, has two stud-type projections 5, which are aligned with one another at some distance to each other.

As can be seen in FIG. 1b, the brake lining retainer 3 has corresponding form-complementary recesses 6, into which the projections 5 engage when assembled, preferably allowing some clearance.

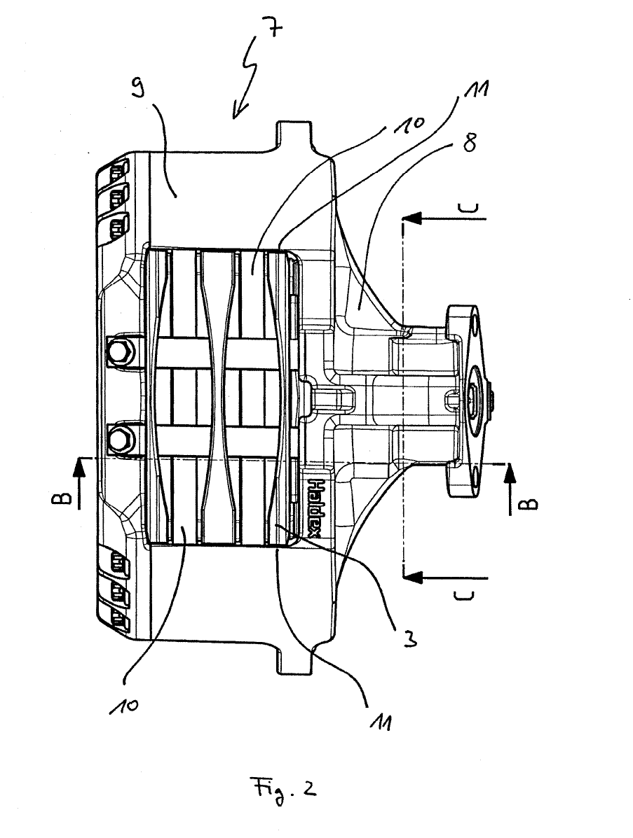

FIG. 2 shows a disk brake in aerial view, in which the aforementioned elements are integrated.

The disk brake has a brake caliper 7 having a brake caliper housing 8 to receive the actuation mechanism, not shown in detail, and two blades or arms 9, which extend over two brake disks 10.

The brake lining retainer 3 is moved laterally on the arms 9, radially, tangentially, and axially, with guide surfaces 11.

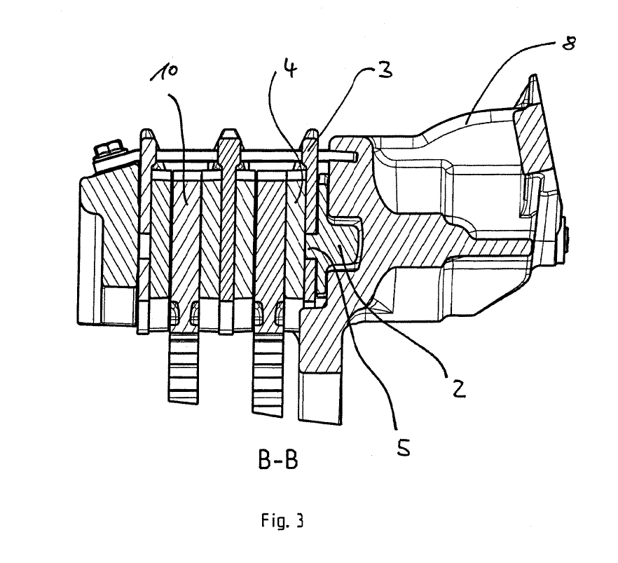

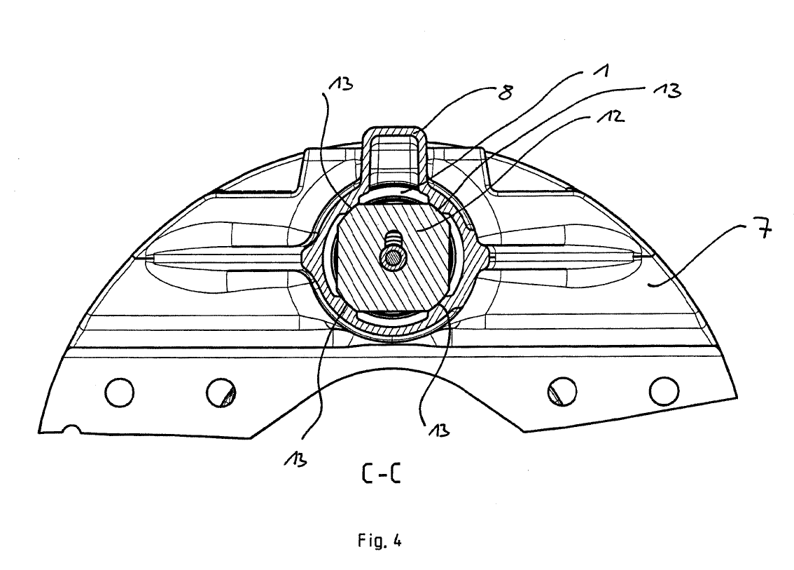

As can be seen in the sectional view in FIG. 3, the pressure plate 2 is connected by the studs 5 with the brake lining retainer 3. In addition it can be seen in the sectional drawing of FIG. 4 that the push rod 1 or parts 12 of the reinforcing mechanism that are in force-transmitting connection with the push rod 1, and of the adjustment mechanism inside the brake disk housing 8 are moved axially on four slide surfaces 13 that are placed opposite one another.

Because the pressure plate 2 is connected with the brake lining retainer 3, the push rod 2 is moved, sliding axially, in the brake caliper housing 8 over slide surfaces 13 and guide surfaces 11.

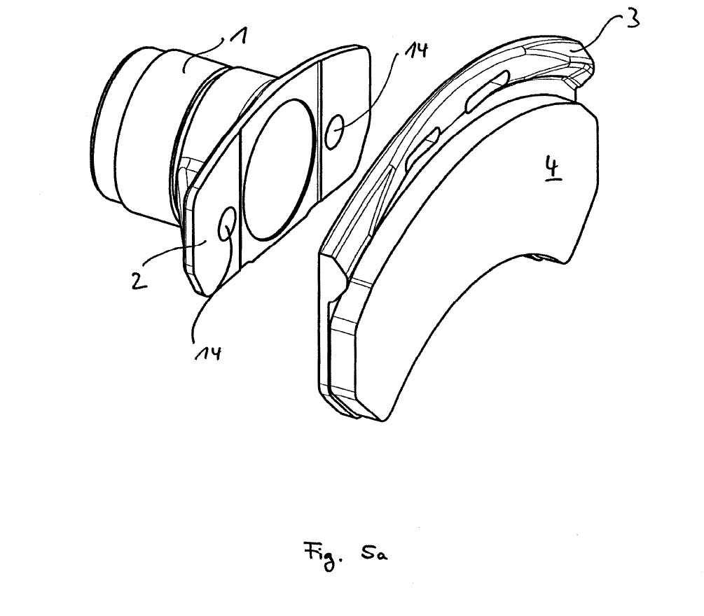

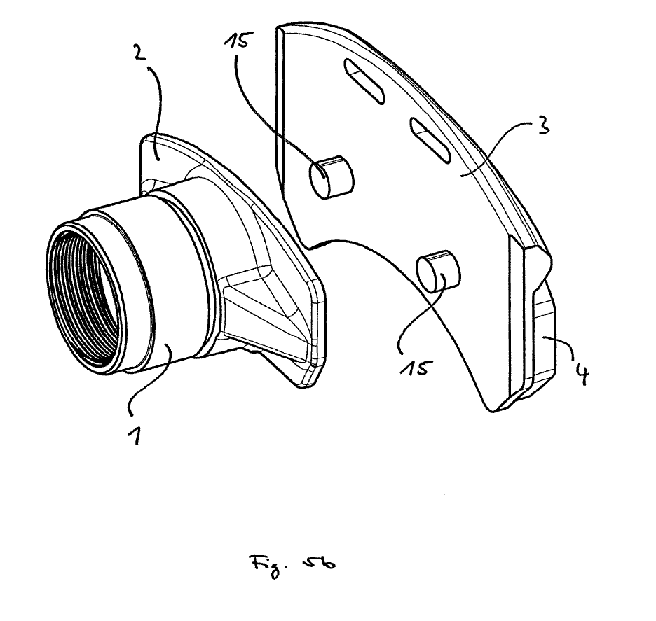

Another embodiment of the invention is illustrated in FIGS. 5a and 5b. Here the pressure plate 2 has recesses 14, into which the form-complementary stud-type projections 15 engage on the brake lining retainer 3, thus connecting both elements to one another while avoiding lateral or radial relative motions.

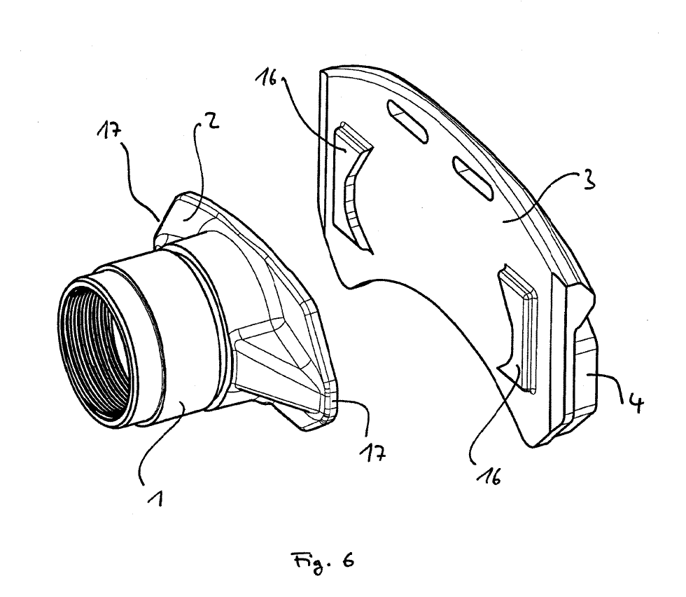

FIG. 6 shows a preferred embodiment of the invention in which the brake lining retainer 3 has two U-shaped projections 16 at a distance from one another, which have a contour whereby they enclose the lateral edges 17 of the pressure plate 2 and thus ensure radial and tangential fixing of the pressure plate 2 on the brake lining retainer 3.

In order to maintain both elements, the pressure plate 2 and the brake lining retainer 3, in a connection that allows perfect withdrawal of the brake lining 4 even during brake force release, in a few embodiments, in which the tolerance of the clearance between connecting elements 5 and 6, 14 and 15, and 16 and 17, does not in itself permit this, an additional spring clamp 18 can be provided to overlap the pressure plate 2 and the brake lining retainer 3 and connect them securely with one another. This spring clamp 18 ensures that the brake lining 4 is immediately withdrawn from the brake disk when a replacement mechanism moves the push rod 1 back into its starting position.

1. A disk brake consisting of a brake caliper that overlaps at least one brake disk and a brake actuation mechanism that is enclosed in the brake caliper and includes a reinforcing mechanism to convey braking force into a push rod, which is positioned so that it can slide in the brake caliper and has on its brake disk end a pressure plate in order to transmit the braking force by a brake lining retainer and a brake lining to the brake disk, and where the brake lining retainer is moved radially and tangentially with the brake lining in the brake caliper or in a carrier that guides the brake caliper, characterized in that the pressure plate is connected with the brake lining retainer in such a way that during brake actuation and brake force release the push rod is moved axially by the brake lining retainer in the brake caliper.

2. A disk brake according to claim 1, wherein the pressure plate on its side facing the brake disk has at least one connecting element, which acts with a form-complementary connecting element, which is positioned on its side facing the brake disk on the brake lining retainer.

3. A disk brake according to claim 2, wherein the pressure plate has two projections at a distance to one another, which engage into two corresponding form-complementary recesses in the brake lining retainer.

4. A disk brake according to claim 2, wherein the pressure plate has two recesses at a distance to one another, into which two corresponding, form-complementary projections of the brake lining retainer engage.

5. A disk brake according to claim 2, wherein the brake lining retainer has a recess, which receives the pressure plate completely, in form complementary manner.

6. A disk brake according to claim 2, wherein the brake lining retainer has two projections opposite one another, which receive the pressure plate, surrounding its sides.

7. A disk brake according to claim 3, wherein between the connecting elements there is, in each case, a clearance with sufficient tolerance so that the pressure plate is fixed radially and tangentially and at the same time replacement of the brake lining retainer is ensured whenever necessary.

8. A disk brake according to claim 1, wherein at least one spring clamp is provided, which extends over the brake lining retainer and the pressure plate, holding them firmly connected to one another.

9. A disk brake according to claim 1, wherein the push rod is configured as a traverse having two parallel adjustment spindles mounted so that they can rotate on it, and the pressure plate interacts with the two adjustment spindles.

10. A disk brake according to claim 1, wherein the push rod is configured as an essentially rotation-symmetric cam with an adjustment spindle mounted on it, and the pressure plate interacts with the adjustment spindle.

11. A disk brake according to claim 9, where in the push rod is moved in the brake caliper in the area of its end that faces the brake disk and on which the reinforcing mechanism is applied.

12. A disk brake according to claim 11, wherein the push rod is moved in the brake caliper on four diagonally opposite slide surfaces.

13. A brake lining retainer for a brake lining for a disk brake, which can be moved radially and tangentially in a brake caliper or in a carrier, which guides the brake caliper, characterized in that devices are provided on the side opposite the brake linings for connecting with a pressure plate of a push rod of a brake actuation mechanism of the disk brake.

14. A brake lining retainer according to claim 13, wherein two recesses are provided at a distance to one another, into which two form-complementary projections of the pressure plate can be received.

15. A brake lining retainer according to claim 13, wherein to projections are provided at a distance to one another, which can be received in two corresponding, form-complementary recesses of the pressure plate.

16. A brake lining retainer according to claim 13, wherein two projections are provided opposite to one another, between which the pressure plate can be received by embracing its sides.
